(19) United States
(12) Patent Application Publication
(10) Pub. No.: US 2013/0118014 A1
(43) Pub. Date: May 16, 2013

(54) DEPOSITING RAZOR CARTRIDGE

(71) Applicant: THE GILLETTE COMPANY, Boston, MA (US)

(72) Inventors: Alison Fiona STEPHENS, Maidenhead (GB); Matthias GESTER, Farnborough (GB); Alan BROOKS, Woking (GB)

(73) Assignee: THE GILLETTE COMPANY, Boston, MA (US)

(21) Appl. No.: 13/670,983

(22) Filed: Nov. 7, 2012

(30) Foreign Application Priority Data
Nov. 10, 2011 (GB) 11188671.9

(51) Int. Cl. B26B 21/44

(52) U.S. Cl. 30/41

(57) ABSTRACT

A razor cartridge comprising a housing, one or more blades disposed within the housing, a moisturizing portion comprising at least 50% lipophilic materials by weight of the moisturizing portion, being disposed within the housing and having a first surface area to contact the skin, and a lubricating portion comprising at least 20% lubricants by weight of the lubricating portion, being disposed within the housing and having a second surface area to contact the skin, wherein the ratio of the first surface area to the second surface area is in the range of from 1:5 to 5:1.

### FIELD OF THE INVENTION

The present invention concerns the provision of a razor cartridge comprising a portion of moisturizing material and a portion of lubricating material.

### BACKGROUND OF THE INVENTION

Hair removal devices incorporating a chemical composition are known and shall be referred to herein as devices comprising an “onboard” composition. Reference can be made to WO 07/056509 which teaches the inclusion of an onboard soap composition in a wet shaving razor. It is also known to provide a wet shaving razor incorporating an onboard skin-engaging composition comprising large quantities of hydrophilic polymers, such as polyethylene oxide, to lubricate the skin. Reference is made, by way of example, to WO 97/02116 and WO 97/02117.

The patent applications referred to above relate to the provision of various advantages, such as additional lathering and soap-related benefits, or improved lubrication in the case of polyethylene oxide. It has been considered advantageous to be able to provide a skin moisturizing benefit via an onboard chemistry, especially to male users who may be less motivated to use skin moisturizers than females. The provision of a moisturizing benefit from an onboard chemistry may, however, have a number of difficulties associated with it.

An approach available to promote skin moisturization is to use occlusive, hydrophobic materials which cover the skin and therefore act to retain water already present therein. These materials are typically emollients which are less likely to be washed away during use in a highly aqueous environment than polyols or other water-binding agents. WO 06/108522 discloses the use of small amounts of hydrophobic emollients in an onboard chemistry. US 2009/0223057 discloses shaving aid strip compositions comprising polyoxyethylene for similar reasons to the above-discussed documents. In order to improve the longevity of the shaving aid, the polyoxyethylene is mixed with larger amounts of amphipathic, but generally hydrophobic materials, such as fatty alcohols.

However, formulations comprising significant proportions of hydrophobic materials may give rise to increased drag across the skin, due to the affinity of such materials with the hydrophobic skin surface. Users report that increased drag tends to increase discomfort during shaving. Accordingly, there remains a need for a skin moisturizing razor cartridge offering increased comfort.

### SUMMARY OF THE INVENTION

In a first aspect, a razor cartridge is provided, comprising a housing, one or more blades disposed within the housing, a moisturizing portion comprising at least 50% lipophilic materials by weight of the moisturizing portion, being disposed within the housing and having a first surface area to contact the skin, and a lubricating portion comprising at least 20% lubricants by weight of the lubricating portion, being disposed within the housing and having a second surface area to contact the skin, wherein the ratio of the first surface area to the second surface area is in the range of from 1:5 to 5:1.

In a second aspect, a razor is provided, comprising a cartridge according to the first aspect of the invention.

### BRIEF DESCRIPTION OF THE DRAWINGS

FIG. 1. is a side view of a razor cartridge according to the invention, with the moisturizing portion and lubricating portion positioned behind the blades

FIG. 2. is a face view of a razor cartridge of FIG. 1.

FIG. 3. is a side view of a razor cartridge according to the invention, with the lubricating portion positioned behind the moisturizing portion.

FIG. 4. is a face view of a razor cartridge of FIG. 3.

FIG. 5. is a side view of a razor cartridge according to the invention, with the lubricating portion positioned ahead of the blades and the moisturizing portion positioned behind the blades.

FIG. 6. is a face view of a razor cartridge of FIG. 5.

FIG. 7. is a side view of a razor cartridge according to the invention, with the lubricating portion positioned behind the blades and the moisturizing portion positioned ahead of the blades.

FIG. 8. is a face view of a razor cartridge of FIG. 7.

FIG. 9. is a side view of a razor cartridge according to the invention, with the moisturizing portion and lubricating portion positioned ahead of the blades, and the moisturizing portion behind the lubricating portion.

FIG. 10. is a face view of a razor cartridge of FIG. 9.

FIG. 11. is a side view of a razor cartridge according to the invention, with the moisturizing portion and lubricating portion positioned ahead of the blades and the moisturizing portion ahead of the lubricating portion.

FIG. 12. is a face view of a razor cartridge of FIG. 11.

FIG. 13 is a side view of a razor comprising a razor cartridge according to the invention.

### DETAILED DESCRIPTION OF THE INVENTION

A razor cartridge is provided comprising a housing which may have a front edge and a rear edge. The housing may be connectable to a handle via means known to the man skilled in this art and which need not be elaborated here, or may be integral with the handle, in either case forming a completed razor. At least one blade is disposed within the housing, the blade(s) having tips, or cutting edges, directed towards the front of the razor cartridge and that may be aligned in a cutting plane and to cut in a cutting direction. The razor cartridge comprises a moisturizing portion, or moisturizing block/strip, and a lubricating portion, or lubricating block/strip, both disposed within the housing.

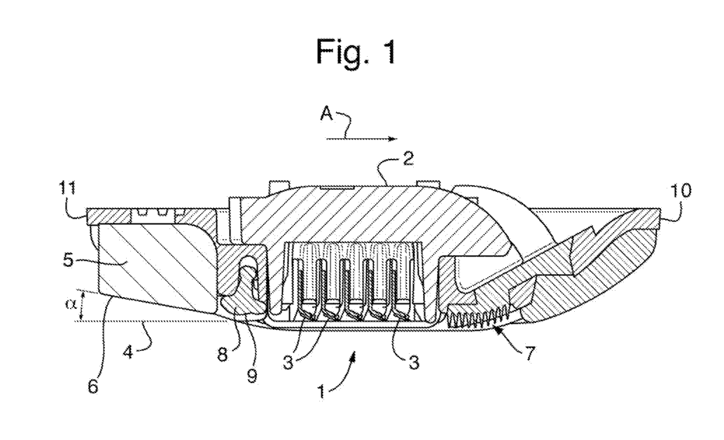

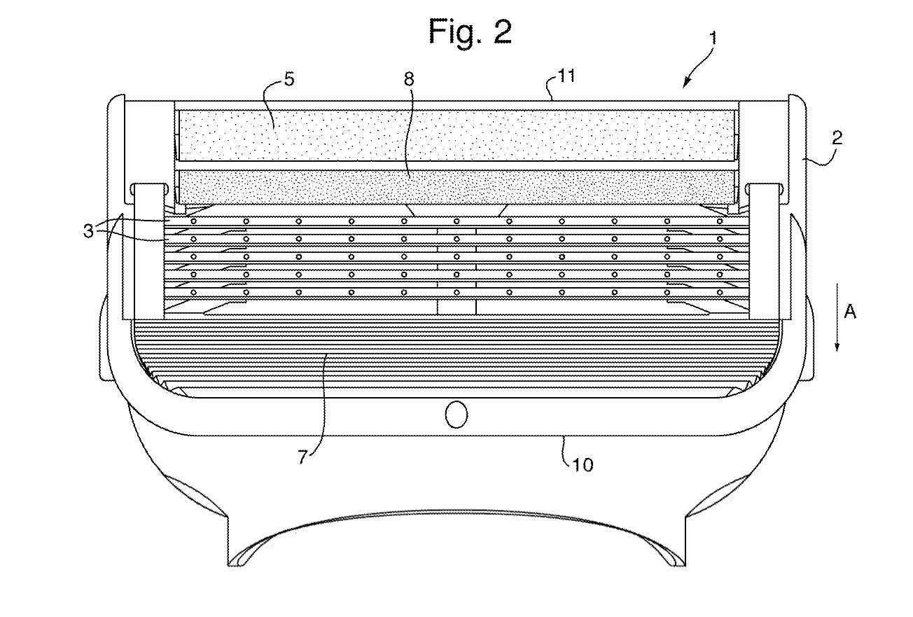

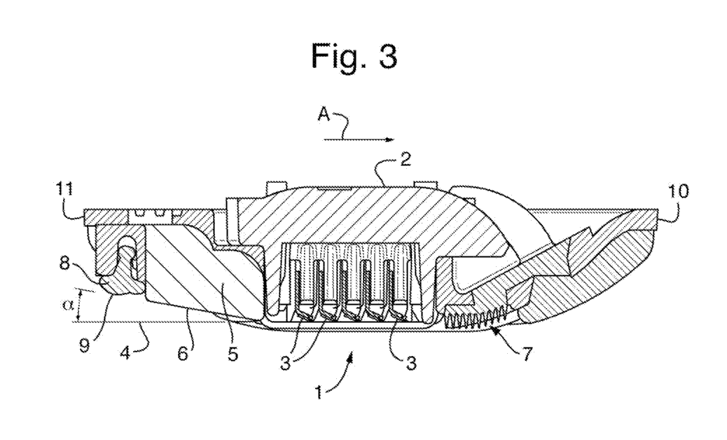

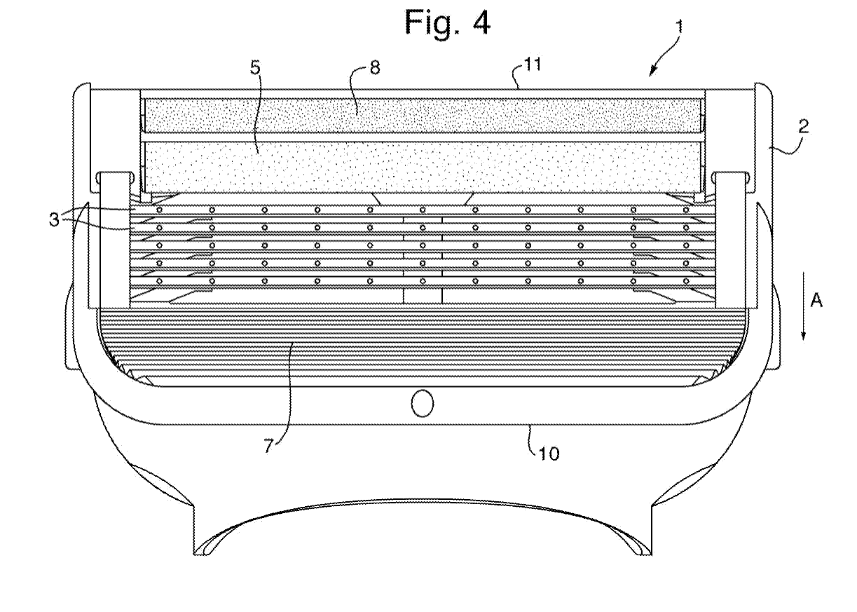

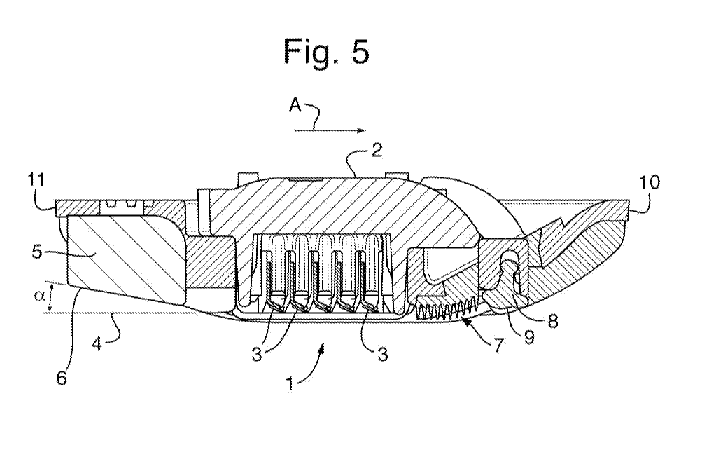

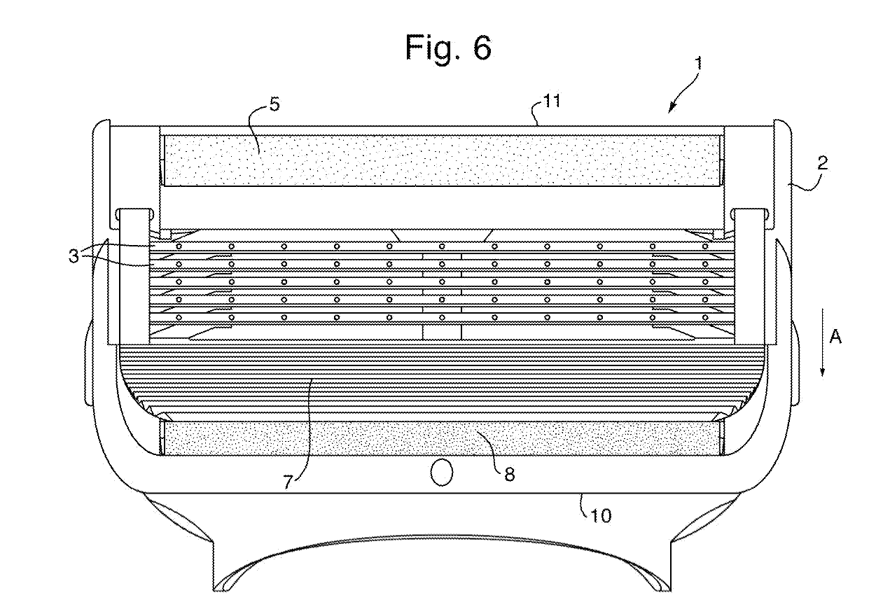

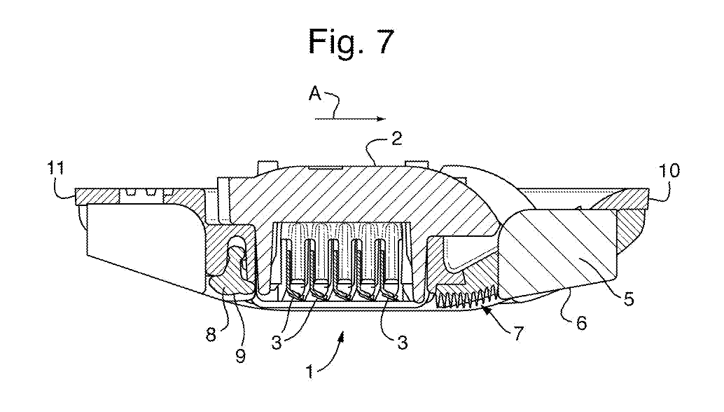

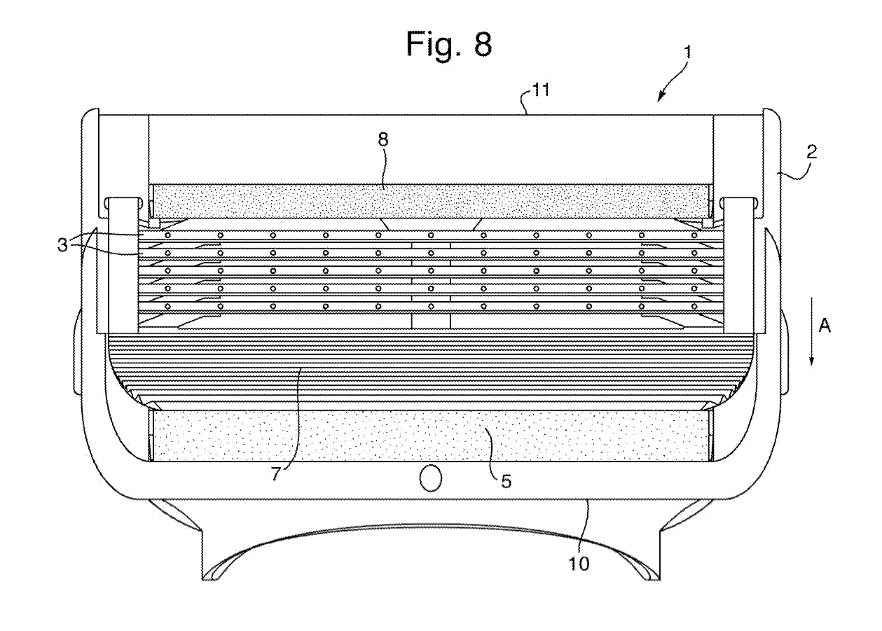

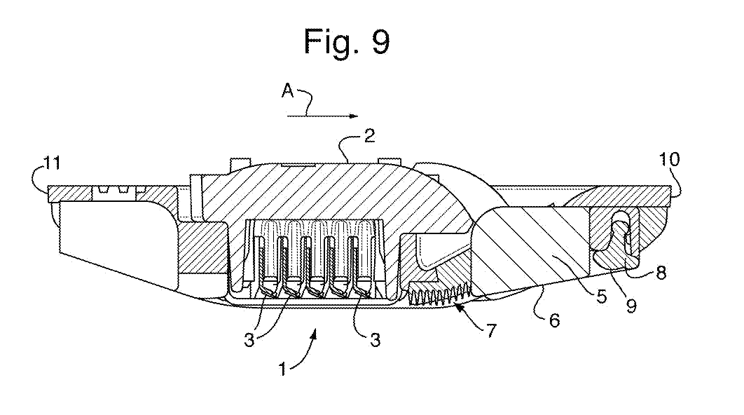

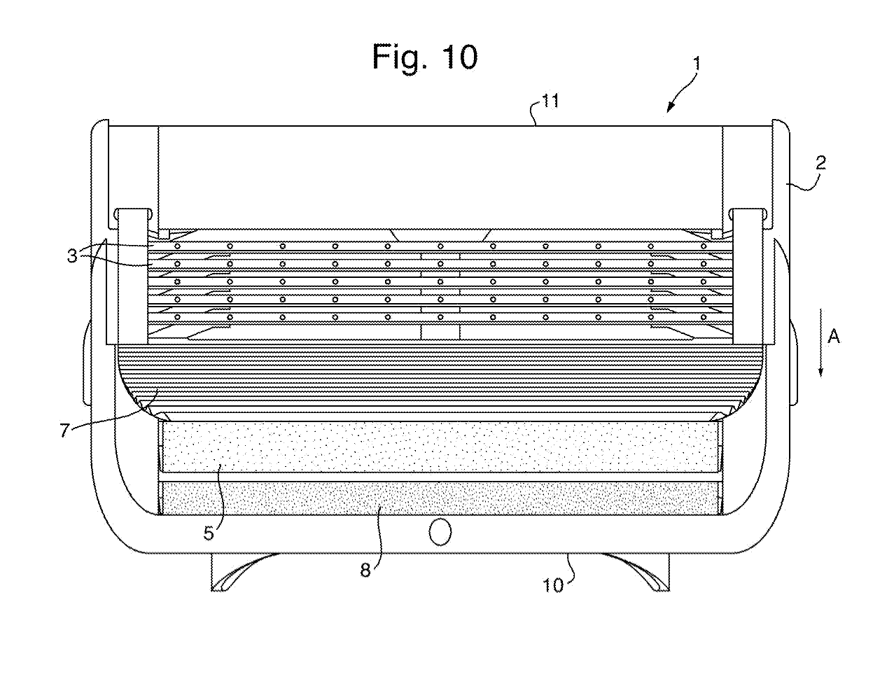

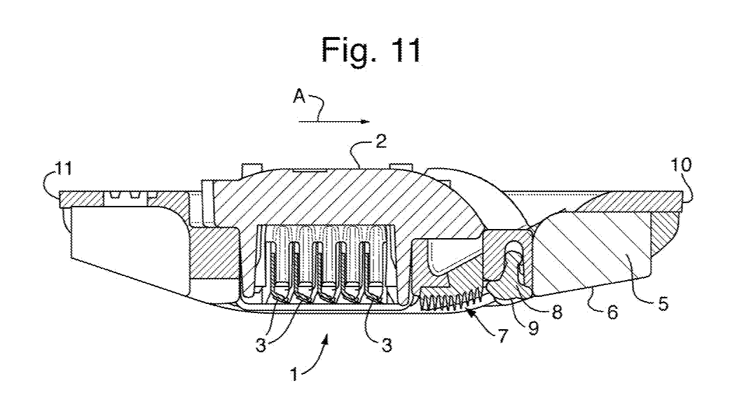

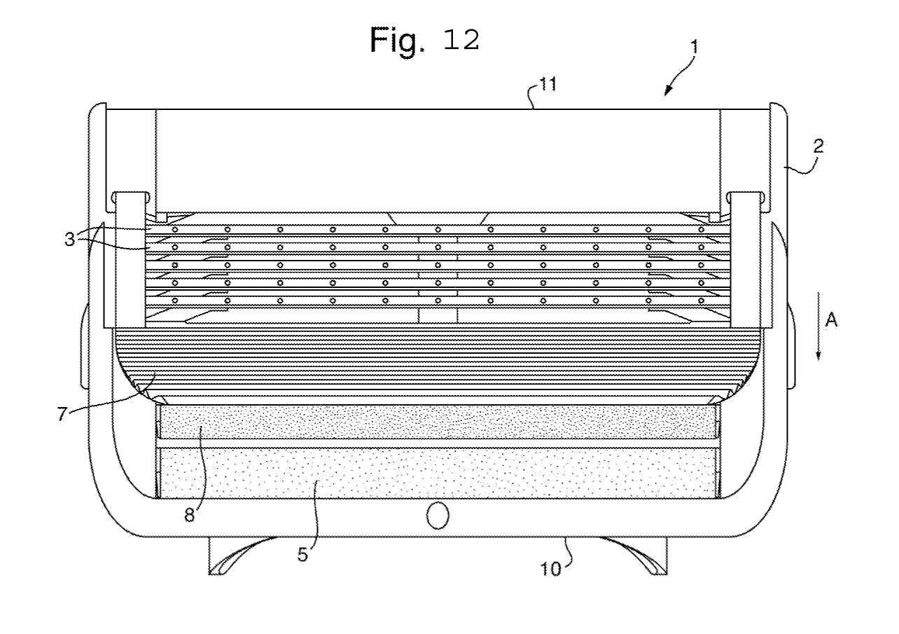

FIG. 1 depicts a razor cartridge (1) comprising a housing (2) which has a front edge (10) and a rear edge (11). The cartridge (1) comprises one or more blades (3) disposed within the housing and between the front edge (10) and rear edge (11), the blades comprising tips or cutting edges that may be aligned in a cutting plane (4) to cut in a cutting direction (A). Cutting direction (A) is typically substantially perpendicular to the cutting edges of blades (3). The cartridge also comprises a moisturizing portion (5) and lubricating portion (8), each also disposed between the front edge (10) and rear edge (11). The moisturizing portion (5) comprises first surface area (6) to contact the skin and the lubricating portion (8) comprises second surface area (9). The cartridge may further comprise a front skin-engaging element (7). FIG. 2 shows a face view of the razor cartridge (1) of FIG. 1. FIGS. 3-12 show razor cartridges according to the invention, having other positional arrangements of the moisturizing and lubricating portions in relation to each other and the blades (3) or skin-engaging elements (7).

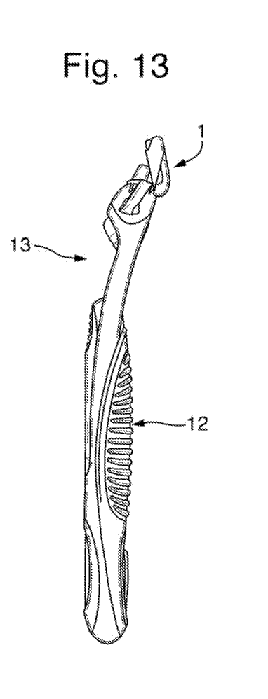

As shown in FIG. 13, the wet shaving razor cartridges of the present invention may be mounted on a handle (12) with the intention that the entire razor should be discarded when the sharp edges of the blades (3) have become dull. Alternatively, the wet shaving cartridges of the present invention may be detachably mounted to a handle (12) so that the cartridge may be replaced on the handle (12) when the blade edges have lost the sharpness required for efficient shaving. In typical cartridges, the blades are usually carried by the housing (2), which is generally a molded plastic frame, and the blades (3) may then be supported to move within the frame, either independently of each other or in unison, under forces imparted on the blades (3) by the skin during shaving. In one embodiment, for support within the housing, the blades (3) are mounted fixedly within slots in a blade retaining member. In another instance, the blades may be floatably mounted within the housing. Here, the plurality of blades is supported by one or more spring loaded blade retaining members where such blades are permitted to respond to the forces encountered during shaving.

In each embodiment of the invention, the level of comfort obtained with any given wet shaving razor cartridge is influenced strongly by the shaving geometry, which is the relative positioning of the skin contacting components. Important parameters of the shaving geometry include the blade exposure which is the distance by which the tip of the blade edge projects above, or is retracted below, a plane which is tangential to the skin contacting parts next in front and next behind the blade edge, the blade tangent angle (also known as the blade shaving angle) which is the angle at which the plane of the blade is inclined to a plane which is tangential to the guard and the cap surfaces (the tangent plane), and the blade span which is the distance by which the blade edge is spaced from the skin contacting element immediately in front of the blade edge, as seen in a plane which is tangential to the blade edge and the skin contacting element in front of it. A progressive blade exposure may be used in the present invention as detailed in U.S. Pat. No. 6,212,777.

The moisturizing and lubricating portions may be in any desired location on the cartridge.

The lubricating portion (8) may be placed in front of (i.e. ahead of, or towards the front of the cartridge from) the moisturizing portion to provide lubricant to the area of skin over which the moisturizing portion will pass and thus directly reduce the drag resulting from the moisturizing portion. Alternatively, the lubricating portion (8) may be placed behind (i.e. to the rear of, or towards the rear of the cartridge from) the moisturizing portion or interspersed within (but not forming a single chemical composition with) the moisturizing portion (e.g. forming stripes or another pattern within the moisturizing portion).

The moisturizing portion (5) and lubricating portion (8) may each be placed in front of the blades or each behind the blades (e.g. all of the blades), for example adjacent to one another as shown in FIG. 2, in order to improve the provision of lubricant directly ahead of the moisturizing portion without any other skin contacting element of the cartridge removing some or all of the lubricant from the skin. Alternatively, the moisturizing portion (5) and lubricating portion (8) may be non-adjacent, such as on opposite or opposing sides of the blades or a skin-engaging element (7), i.e. one of the moisturizing portion and lubricating portion may be placed ahead of the blades, and the other behind the blades. For example, the lubricating portion (8) may be placed in front of the blades, and the moisturizing portion (5) may be placed behind the blades.

Placing the lubricating portion (8) in front of the blades (3) allows lubricant to be provided to the area of skin being shaved before the blades pass over the same area in order to improve the comfort of shaving. The lubricating portion (8) may be additionally or alternatively be placed behind the blades, or between them if more than one blade is present.

Placing the moisturizing portion (5) behind the blades (3) allows the lipophilic material to be provided to the shaved area of skin after the blades have passed over it, in order to reduce the likelihood that lipophilic material is removed by the blades. Similarly, placing the moisturizing portion (5) behind other skin-contacting features of the razor cartridge, such as any skin-engaging element (7) or the lubricating portion (8), reduces the likelihood that any such skin-contacting features of the razor cartridge remove some of the lipophilic material. Accordingly, the moisturizing portion may be placed at the rear of the razor cartridge. Additionally or alternatively, the moisturizing portion may be located in front of one or more skin-contacting features, such as a skin-engaging element (7) or blades (3).

The lubricating portion and moisturizing portion may be aligned in the direction parallel to the cutting edges of the blades (as shown in the figures), or so that the midpoint of the moisturising portion along the direction of the cutting edges is co-located along that direction with the corresponding midpoint of the lubricating portion. In other words, at least the area over which the first surface area (6) passes during use of the razor cartridge is also passed over by the second surface area (9). This allows lubricant to be provided to all of the skin over which the moisturizing portion will subsequently pass. Additionally, in use, the second surface area (9) may also pass over areas which the first surface area does not during a typical shaving stroke. Alternatively, the moisturising portion and lubricating portion may be offset along the direction of the cutting edges. Further to the above, the lubricating portion may have a length at least equal to the length of the moisturizing portion, the length being parallel to the cutting edges of the blades, i.e. perpendicular to the cutting direction (A) within cutting plane (4), or from left to right or right to left when viewing FIG. 2.

The moisturizing portion has a first surface area for contacting the skin and the lubricating portion has a second surface area for contacting the skin. The lubricating composition reduces the drag but may also reduce the friction between the skin and the hydrophobic portion, leading to reduced deposition of the emollient and reducing the skin moisturizing benefit afforded.

The ratio of the first surface area to the second surface area is in the range of from 1:5, 1:3, 1:2.5 or 1:2 to 2:1, 2.5:1, 3:1 or 5:1. For example, the ratio of the first surface area to the second surface area is in the range of from 1:5 to 5:1, preferably from 1:3 to 3:1, more preferably from 1:2.5 to 2.5:1, and even more preferably from 1:2 to 2:1. Within the ranges specified, appropriate lubrication is provided to reduce the drag arising from the presence of the moisturizing portion, while also helping to avoid a reduction in the effect of the moisturizing portion. In particular, an increasingly improved balance between reduced drag and moisturization effectiveness is achieved within the narrower ranges by providing a balance between the surface area available to provide lubricant to the skin and the surface area available to provide hydrophobic material to the skin.

In some embodiments, the ratio of the first surface area to the second surface area may be calculated by comparing only the surface area of the lubricating portion that is directly ahead of or behind the surface area of the moisturizing portion. In this respect, additional lubricating portion may be provided on the cartridge, e.g. at the sides of the blades, that does not therefore provide lubrication directly in the line of the moisturizing portion. This enables the beneficial surface area ratio to be utilized in respect of the area of skin over which the moisturizing portion passes, while augmenting the razor cartridge with additional lubricant that does not influence the moisturizing portion, leading to increased lubricity being delivered to the shaving experience as a whole while avoiding negatively impacting the effectiveness of the moisturizing portion.

The first surface area of the moisturizing portion and the second surface area of the lubricating portion may be planar or may define a shallow convex and/or concave curve. If the first and/or second surface area is planar, it may provide a higher surface area for deposition than a convex or concave surface. The first surface area may also slope away from the tips of the blades towards the base of the razor cartridge which may further reduce the drag experienced by users, while facilitating deposition of moisturiser by the moisturizing portion. In order to enhance this benefit, the surface area may slope such that all tangents to the surface area are at an acute angle, α, to the cutting plane. In order to better balance the reduction in drag and maintenance of good skin contact, the angle, α, may be from 5° to 15°.

The moisturizing portion and lubricating portion may have any desired geometry. For example, the lubricating portion may extend across the full width of a shaving system or razor cartridge, or only part of its width. Moreover, the portions need not be in the form of straight strips that extend lengthwise. The moisturizing and lubricating portion may have an arcuate shape, e.g., it may be in the form of a molded ring that surrounds the blades of an approximately oval-shaped razor cartridge. Alternatively, the composite may be manufactured as an elongated strip and then positioned to surround the blades and clamped in place in a roughly oval shape, e.g., as disclosed in U.S. Pat. No. 5,604,983.

The moisturizing portion and lubricating portion may also have any desired cross-sectional shape, for instance wedge-shaped, square or rectangular in cross-section. If the housing and portion do not include corresponding features for locking engagement, the portion may be glued to the housing or attached in any other desired manner, e.g., by insert molding or slot coating.

The lubricating portion and moisturizing portion may each independently be, for example, from 25 mm to 35 mm, preferably from 28 mm to 33.5 mm, and more preferably from 29.5 mm to 32.5 mm in length (e.g. parallel to the cutting edges of the blades), and from 1 mm to 3.0 mm, preferably from 1.5 mm to 2.5 mm and more preferably from 1.75 mm to 2.25 mm in width (e.g. along the cutting direction (A)) at their widest point. The lubricating portion and moisturizing portion may each independently have an overall height (e.g. perpendicular to cutting plane 4), for example, from 2 mm to 2.5 mm, preferably from 2.25 mm to 2.45 mm, more preferably from 2.3 mm to 2.35 mm, measured along the longest distance between the first or second surface area and the corresponding distal surface of the portion.

The moisturizing portion is configured to be erodable, such that it erodes during and as a result of shaving human skin, to leave moisturizing deposits on the skin. As used herein, the word “erodable”, when used in relation to the moisturizing portion, includes a moisturizing portion having a Chatillon Hardness at 25° C. of 0.50-3.25kg, preferably 0.75-3.00 kg, more preferably 1.00-2.50 kg, measured according to the protocol provided hereinbelow. Within these ranges, beneficial rates of wear may be achieved. In order to provide effective moisturization, the moisturizing portion comprises at least 50%, preferably from 60% to 98%, more preferably from 70% to 95% and even more preferably from 80% to 93% lipophilic materials by weight of the moisturizing portion. Alternatively, the moisturizing portion may be configured to deposit one or more lipophilic materials at a combined amount of from 0.5 μg/cm² to 100 μg/cm² preferably from 1 μg/cm² to 50 μg/cm², more preferably from 2 μg/cm² to 20 μg/cm², even more preferably from 3 μg/cm² to 15 μg/cm². Following the use of a razor cartridge upon the skin, the amount of lipophilic material deposited may be determined by solvent extraction in combination with high pressure liquid chromatography (HPLC), or another known method.

The lipophilic materials may be liquid, semi-solid and/or solid at room temperature and may comprise one or more hydrocarbons, fatty acids, fatty alcohols, esters, triglycerides, fats, butters, waxes, lipophilic skin active agents or mixtures thereof.

Advantageously, if solids or semi-solids are present, then the moisturizing portion comprises, by weight of the moisturizing portion, less than 20%, preferably less than 5% and more preferably no (i.e. is substantially free of) materials having a melting point of more than 100° C. This is because excessive quantities of such materials may render the moisturizing portion less flexible and therefore more liable to crack during manufacture and/or use.

Liquid, semi-solid, or solid hydrocarbon lipophilic materials which may be comprised within the moisturizing portion include straight chain, branched chain, saturated and unsaturated hydrocarbons and mixtures thereof and they may comprise natural or synthetic hydrocarbon emollients and mixtures thereof. Preferred natural hydrocarbon emollients include petrolatum, mineral oil and mixtures thereof. Preferred synthetic hydrocarbon emollients include branched chain hydrocarbons, such as isohexadecane (such as Arlamol HD™ from Croda) and Polydecene (such as Puresyn 2™ from Exxon Mobil).

Liquid, semi-solid, or solid fatty alcohol or fatty acid emollients which may be comprised within the moisturizing portion include saturated and unsaturated higher alcohols, especially C₁₂-C₃₀ fatty alcohols and fatty acids, especially lauric, myristic, palmitic, stearic, arachidic or behenic alcohols/acids.

Liquid, semi-solid, or solid ester emollients which may be comprised within the moisturizing portion include esters of a C₁₂-C₃₀ alcohol and mixtures thereof, especially isopropyl myristate, isopropyl isostearate and mixtures thereof.

Liquid, semi-solid, or solid triglyceride emollients which may be comprised within the moisturizing portion include synthetic or natural triglycerides, especially natural triglycerides derived from sunflower, avocado, olive, castor, coconut, cocoa and mixtures thereof. More preferred are coconut-derived triglycerides, such as the commercially available materials Myritol™ 312 and 318 (Cognis), Estasan™ (Croda) and Miglyol™ (Sasol).

Liquid, semi-solid, or solid fat and butter emollients which may be comprised within the moisturizing portion include coconut butter, shea butter and mixtures thereof.

Liquid, semi-solid, or solid wax emollients which may be comprised within the moisturizing portion include paraffin wax, microcrystalline wax, candellila, ozokerite and mixtures thereof, preferably paraffin wax. Advantageously, the moisturizing portion comprises some wax because waxes may bestow improved hardness and erodability to the moisturizing portion, although, as discussed above, the presence of too much wax may render the composition less flexible and therefore more liable to crack during manufacture and/or use. Preferably, therefore, the moisturizing portion comprises from 2% to 20% and more preferably from 3% to 15% wax by weight of the moisturizing portion.

The moisturizing portion may additionally comprise a structuring polymer to prevent excessively rapid erosion of the moisturizing portion. Preferably, the moisturizing portion comprises from 2% to 50%, preferably from 3% to 40%, more preferably 4% to 12% of structuring polymer by weight of the moisturizing portion.

As defined herein, the structuring polymer is not regarded as being one of the “lipophilic materials” as defined above and should be ignored for the purposes of calculating the percentage weights of the “lipophilic materials”.

Advantageously, the structuring polymer comprises a block copolymer. More advantageously, the block copolymer comprises a di-block copolymer, a tri-block copolymer, a multi-block copolymer, a radial block copolymer, a random block copolymer, or a mixture of these polymers.

In the case in which the block copolymer comprises a tri-block copolymer, then the tri-block copolymer preferably comprises a linear ABA tri-block polymer. Without wishing to be bound by theory, applicants believe that the A blocks aggregate creating domains, within which the moisturizing hydrophobic phase may accumulate, connected together by the B-blocks. This structure may provide an appropriate hardness to bestow the requisite wear properties to the moisturizing portion, while also being flexible enough to be processed and not to crack or break during processing and/or use.

Advantageously, the linear ABA block copolymer comprises styrene-butadiene-styrene (SBS) block copolymer, styrene-isoprene-styrene (SIS) block copolymer, styrene-ethylenebutylene-styrene (S-EB-S) block copolymer, or mixtures thereof. More advantageously, the linear ABA block copolymer preferably comprises styrene-ethylenebutylene-styrene (S-EB-S) block copolymer. More advantageously still, the weight ratio of styrene to butadiene in the S-EB-S is in the range 20:80 to 40:60 and preferably around 30:70.

Particularly useful commercially available ABA block copolymers include Versagel™ materials available from Penreco and the Kraton™ G series, especially G-6150, G-1651, G-1652 and 1654.

As discussed above, the structuring polymer comprised within the moisturizing portion may comprise a random block copolymer. An example of a suitable random block copolymer is ethylene vinyl acetate (EVA) which is a copolymer of ethylene and vinyl acetate. Advantageously, the amount of ethylene comprised within the EVA polymer is from 65-90%, preferably from 70-85% by weight of the EVA to give beneficial wear properties. A commercially available range of EVA is called Elvax™, which is commercialised by DuPont.

The moisturizing portion may comprise one or more additional components which bestow a suitable melt viscosity to the composition, such as oil phase gellants, to facilitate improved processing, provided that the additional component(s) do not significantly reduce the hardness or erodability of the moisturizing portion. Examples of such components are trihydroxystearin, which is commercially available as Thixcin R™ (manufactured by Elementis Specialities), ethylene vinyl acetate (EVA) and mixtures thereof.

A moisturizing portion according to the invention may be manufactured by heating the lipophilic materials to a suitable temperature to melt them, typically approximately 130° C., after which the structuring polymer is added and mixed well until the structuring polymer has dissolved. The mixture is then cooled, typically to approximately 90° C., after which any additional ingredients may be added. In a final step, the mixture is poured into suitable containers or moulds and allowed to cool to room temperature.

Once the mixture has set to form a moisturizing portion, it may be affixed to a razor cartridge in any appropriate fashion. One such approach is to mould the moisturizing portion directly onto the cartridge. Another approach involves directly or indirectly adhering the moisturizing portion to the cartridge by means of an adhesive composition. One method of indirect adherence involves casting the moisturizing portion onto a sheet of an appropriate substrate, such as an acetate sheet, which sheet is then adhered to the cartridge, for example mechanically or via an adhesive.

The lubricating portion having a second surface area comprises at least 20% lubricant by weight of the lubricating portion. Preferably, the lubricating portion comprises from 30% to 80% and more preferably from 40% to 75% lubricant by weight of the lubricating portion. Alternatively, the lubricating portion may be configured to deposit one or more lubricants during use at a combined amount of from 20 μg/cm² to 100 μg/cm². Following the use of a razor cartridge upon the skin (but before rinsing with water), the amount of lubricant deposited may be determined by a cup scrub or solvent extraction in water in combination with high pressure liquid chromatography (HPLC), or another known method.

The lubricant may be any known to the person skilled in the art, but is preferably water soluble (i.e. hydrophilic), or lipophobic. Selecting such a lubricant further helps to mitigate the interaction between the blades and the skin. Examples of water soluble lubricants include water-soluble polymers.

A preferred lubricous water-soluble polymer is polyethylene oxide. The more preferred polyethylene oxides generally are known as POLYOX (available from Union Carbide Corporation) or ALKOX (available from Meisei Chemical Works, Kyoto, Japan). These polyethylene oxides will preferably have molecular weights of from 100,000 to 6 million, more preferably from 300,000 to 5 million. The most preferred polyethylene oxide comprises a blend of from 40% to 80% of polyethylene oxide having an average molecular weight of about 5 million (e.g. POLYOX COAGULANT) and from 60% to 20% of polyethylene oxide having an average molecular weight of about 300,000 (e.g. POLYOX WSR-N-750) . The polyethylene oxide blend may also advantageously contain up to about 10% by weight of a low molecular weight (i.e., MW<10,000) polyethylene glycol such as PEG-100. The polyethylene oxide may be provided, for example, in powder or pellet form. The lubricating portion may contain, for example, at least 20% preferably from 30% to 80%, or more preferably from 40% to 75% by weight of a lubricous water soluble polymer, especially polyethylene oxide or polyethylene glycol, and more especially the combination of polyethylene oxide and polyethylene glycol.

The lubricating portion may further comprise one or more water-insoluble polymers to provide structure to the lubricating portion. Examples of suitable water-insoluble polymers which can be used include polyethylene, polypropylene, polystyrene, butadiene-styrene copolymer (e.g. medium and high impact polystyrene), polyacetal, acrylonitrile-butadiene-styrene copolymer, ethylene vinyl acetate copolymer and blends such as polypropylene/polystyrene blend. Preferably, the lubricating portion includes from 5% to 50%, more preferably from 15% to 40%, even more preferably from 20% to 35% water insoluble polymer by weight of the lubricating portion. The more preferred water-insoluble polymer is polystyrene, preferably a general purpose polystyrene such as BASF 2824 or a high impact polystyrene (i.e. polystyrene-butadiene), such as Mobil 4324. The portion should contain a sufficient quantity of water-insoluble polymer to provide adequate mechanical strength, both during production and use.

The lubricating portion may also contain other conventional shaving and composite ingredients, such as low molecular weight water-soluble release enhancing agents such as polyethylene glycol (e.g., 1-10% by weight), colorants, antioxidants and preservatives. Water-soluble release enhancing agents are described in U.S. Pat. No. 5,113,585. Portions that contain a colorant can be designed to release the colorant, and change color, during shaving, preferably in response to wear of the portion. A portion may contain, for example, from 0.1% to 5%, preferably from 0.25% to 3%, or more preferably from 0.5% to 2% colorant by weight.

The lubricating portion (particularly when located ahead of the moisturizing portion) may further comprise an oil, especially mineral oil, in an amount from 0.5% to 10%, preferably from 2% to 6%, more preferably from 3.5% to 4.5% by weight of the lubricating portion. In some cases, the concentration of mineral oil by weight of the lubricating portion is in the range of 0.1% to 1.5%, for example from 0.12% to 1.2%. The addition of an amount of mineral oil as above may create a more hydrophobic surface on the skin which can then encourage deposition of the lipophilic material from the moisturizing portion.

The lubricating portion can be prepared by conventional coextrusion or molding methods known to those skilled in the art, as discussed in U.S. Pat. No. 5,956,848. Once cooled, the composite can be cut to the appropriate length and attached to a razor cartridge or shaving system. The lubricating portion may be attached to the housing in any desired manner. For instance, the lubricating portion may be mounted on the housing using an adhesive, rather than locking the lubricating portion into an opening in the housing, as discussed above.

The moisturizing portion and/or lubricating portion also may include one or more shaving or skin active agents such as conditioning agents selected from the group consisting of humectants, moisturizers, or skin conditioners (e.g. niacinamide and glycerine); skin rejuvenation compositions (for example targeted for fine lines, wrinkles and uneven skin tone including retinoids), cosmetic compositions; anti-inflammatory agents (including corticosteroids); anti-oxidants (including flavonoids) radical scavengers; sunscreen agents; skin cooling or warming agents and the like. The moisturizing portion and/or lubricating portion may comprise one or more skin active agents present in an amount of from 0.001% to 10%, more preferably from 0.01% to 7%, and even more preferably from 0.025% to 5%, by weight of the respective portion.

In particular, the lubricating and/or moisturizing portion may comprise from 0.01% to 5%, preferably from 0.02% to 2.5%, more preferably from 0.05% to 1.5% and even more preferably from 0.1% to 1% by weight of a particulate active such as zinc oxide (ZnO), zinc pyrithione (ZPT), flavenoid or particulate sunscreen (e.g. titanium dioxide), or of a lipophilic active such as vitamin E (or a derivative thereof e.g. vitamin E acetate or tocopherol nicotinate), hexamidine or salicylic acid, or mixtures thereof.

Other liquid, semi-solid, or solid lipophilic skin active agents which may be comprised within the moisturizing portion or lubricating portion include other oil soluble vitamins and agents which have activity on skin, lanolin; ceramides; sterols and sterol esters; camphor; eucalyptol; essential oils and mixtures thereof.

Chatillon Hardness test
Equipment: Chatillon TCD 200 equipped with a digital force gauge

### Sample Preparation

1. Fully melt and cast moisturizing portion into 60 ml weigh boat (70 mm×70 mm×24 mm)
2. Store lipid at 25° C. overnight to equibrilate
3. Carefully remove moisturizing portion from weigh boat prior to hardness testing

### Machine Preparation

A)
1. Prepare Chatillon TCD 200 and digital force gauge according to manufacturers instructions.
2. Set the ramp speed to 47 mm/min
B) Measuring the hardness value at 25° C.:
1. The pointed geometry should be attached to the shaft of ramp for this test method.
2. Place the moisturizing portion as prepared above and on its side onto the metal base plate directly below the centre of the shaft of the ramp. The mid-point of the moisturizing portion should be in line with the centre of the shaft of the ramp.
3. With the moisturizing portion in place below the flat plate the speed set at 47 mm/min and the digital force gauge set at “C Peak” as above, depress the “Down” button on the Chatillon TCD200.
4. Stop the Chatillon TCD200 just as the probe touches the surface of the moisturizing portion and set the distance counter to zero.
5. Reset the force gauge so that it reads zero
6. Depress the “Down” button on the Chatillon TCD200 until the distance counter reads 13 mm, record C Peak reading.

### EXAMPLE

The following table details a moisturizing portion and a lubricating portion which each may be incorporated into a razor cartridge as a strip disposed in front of or behind the blades.

| | | |
|---|---|---|
| Trade Name | INCI Name | % w/w |

Moisturizing Portion

| | | |
|---|---|---|
| White soft paraffin | Petrolatum | 44.0 |
| Mineral oil | Paraffinum Liquidum | 44.0 |
| Kraton G1650E | Hydrogenated Styrene/Butadiene | 5.0 |
| | copolymer | |
| Thixcin R | Trihydroxystearin | 2.0 |
| Paraffin Wax SP206 | Paraffin | 5.0 |

Lubricating Portion

| | | |
|---|---|---|
| Mobil 4324 | High Impact Polystyrene | 33.5 |
| Polyox WSR Coagulant¹ | Polyethylene Oxide (MW 5,000,000) | 33 |
| Polyox WSR N-750¹ | Polyethylene Oxide (MW 300,000) | 22 |
| DOW 4500 | Polyethylene Glycol (MW 4,500) | 10 |
| N/A | Additives and Colorants | 1.5 |

¹Both Polyox WSR components manufactured by Union Carbide Corp. Danbury, CT

The moisturizing portion of the example may be manufactured by heating the hydrocarbons and waxes to 130° C., then adding the linear ABA tri-block polymer (Kraton G1650E) and mixing well until polymer is fully dissolved. The mixture is then cooled to 90° C. and the Thixcin added, after which the mixture may be moulded onto the cartridge and allowed to cool to room temperature. The Chatillon Hardness of the moisturizing portion of the example above is 1.7 and the angle, α, was moulded to be 12.4°.

The lubricating portion may be manufactured by extruding the blend of ingredients through an extruder with a barrel pressure of 124.1 bar (1800 psi) and temperature of about 180° C., and a die pressure of 165.5 bar (2400 psi) and temperature of 185° C., in order to form an extruded strip.

The ratio of the surface area to contact the skin of the moisturizing portion to the surface area to contact the skin of the lubricating portion is 1.5:1.

The dimensions and values disclosed herein are not to be understood as being strictly limited to the exact numerical values recited. Instead, unless otherwise specified, each such dimension is intended to mean both the recited value and a functionally equivalent range surrounding that value. For example, a dimension disclosed as “40 mm” is intended to mean “about 40 mm”.

Every document cited herein, including any cross referenced or related patent or application is hereby incorporated herein by reference in its entirety unless expressly excluded or otherwise limited. The citation of any document is not an admission that it is prior art with respect to any invention disclosed or claimed herein or that it alone, or in any combination with any other reference or references, teaches, suggests or discloses any such invention. Further, to the extent that any meaning or definition of a term in this document conflicts with any meaning or definition of the same term in a document incorporated by reference, the meaning or definition assigned to that term in this document shall govern.

While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

What is claimed is:

1. A razor cartridge comprising:
a. a housing,
b. one or more blades disposed within the housing,
c. a moisturizing portion comprising at least about 50% lipophilic materials by weight of the moisturizing portion, being disposed within the housing and having a first surface area to contact the skin, and
d. a lubricating portion comprising at least about 20% lubricants by weight of the lubricating portion, being disposed within the housing and having a second surface area to contact the skin,
wherein the ratio of the first surface area to the second surface area is in the range of from about 1:5 to about 5:1.

2. The razor cartridge according to claim 1, wherein the lubricating portion and moisturizing portion are positioned on opposing sides of the one or more blades.

3. The razor cartridge according to claim 1, wherein the lubricating portion and moisturizing portion are positioned on the same side of the one or more blades.

4. The razor cartridge according to claim 1, wherein the lubricating portion and moisturizing portion are each positioned either in front of or behind the one or more blades.

5. The razor cartridge according to claim 1, wherein the second surface area is limited to the area of the lubricating portion directly in front of or behind the first surface area.

6. The razor cartridge according to claim 1, wherein the lubricating portion is positioned in front of the moisturizing portion.

7. The razor cartridge according to claim 1, wherein the lubricating portion is positioned in front of the blades.

8. The razor cartridge according to claim 1, wherein the moisturizing portion is positioned behind the blades.

9. The razor cartridge according to claim 1, wherein the blades each have a cutting edge and the lubricating portion and moisturising portion are aligned with one another in a direction parallel to the cutting edge.

10. The razor cartridge according to claim 9, wherein the lubricating portion has a length at least equal to the length of the moisturizing portion, the lengths being measured parallel to the cutting edges.

11. The razor cartridge according to claim 1, wherein the ratio of the surface area of the first surface area to the second surface area is in the range of from about 1:3 to about 3:1

12. The razor cartridge according to claim 11, wherein the ratio of the surface area of the first surface area to the second surface area is in the range of from about 1:2.5 to about 2.5:1.

13. The razor cartridge according to claim 12, wherein the ratio of the surface area of the first surface area to the second surface area is in the range of from about 1:2 to about 2:1.

14. The razor cartridge according to claim 1, wherein the moisturizing portion comprises from about 60% to about 98% lipophilic materials by weight of the moisturizing portion.

15. The razor cartridge according to claim 14, wherein the moisturizing portion comprises from about 70% to about 95% lipophilic materials by weight of the moisturizing portion.

16. The razor cartridge according to claim 1, wherein the lubricating portion comprises from about 30% to about 80% lubricants by weight of the lubricating portion.

17. The razor cartridge according to claim 16, wherein the lubricating portion comprises from about 40% to about 75% lubricants by weight of the lubricating portion.

18. The razor cartridge according to claim 1, wherein the moisturizing portion comprises at least one lipophilic material selected from hydrocarbons, fatty acids, fatty alcohols, esters, triglycerides, fats, butters, waxes, oils or mixtures thereof.

19. The razor cartridge according to claim 1, wherein the lubricating portion comprises a lubricant selected from water soluble polymers.

20. A razor comprising the razor cartridge according to claim 1.
